(19) United States
(12) Patent Application Publication
(10) Pub. No.: US 2018/0068188 A1
(43) Pub. Date: Mar. 8, 2018

(54) VIDEO ANALYZING METHOD AND VIDEO PROCESSING APPARATUS THEREOF

(71) Applicant: Sheng-Hua Peng, Taipei City (TW)

(72) Inventor: Sheng-Hua Peng, Taipei City (TW)

(73) Assignee: COMPAL ELECTRONICS, INC., Taipei City (TW)

(21) Appl. No.: 15/257,922

(22) Filed: Sep. 7, 2016

(51) Int. Cl. G06K 9/00; G06T 7/00; G06K 9/62

(52) U.S. Cl. CPC G06K 9/00758; G06T 7/0097; G06T 2207/10016; G06K 9/00765; G06K 9/6267; G06T 7/0022

(57) ABSTRACT

A video analyzing method and a video processing apparatus are provided. A video is received and the video is decoded to obtain a plurality of frames. The video is divided into a plurality of video segments according to content of the video by analyzing the frames of the video. A similarity level between any two of the video segments is determined by comparing at least one video attribute of the video segments. A repeat frequency of the video segments is identified according to the similarity level between any two of the video segments.

### BACKGROUND OF THE INVENTION

### 1. Field of the Invention

The present invention generally relates to a video analyzing technique, in particular, to a video analyzing method and a video processing apparatus, which are capable of identifying an important video segment of a video.

### 2. Description of Related Art

Along with people's increasing reliance on electronic products, various portable electronic apparatuses such as notebook PCs, personal digital assistants (PDAs), smartphones, and tablet PCs are gradually popularised. As such, along with booming development of communication technique, people start to make discussions, perform interactions and share feelings and information through Internet. For example, users may share their own status, latest news or even locations with their friends, and gradually get used to upload pictures or video to the social networking websites to record their life. That is, the frequency of watching the videos by the users is getting higher these days. Besides, the users may also watch the videos recording movies, TV programs, dramas or some specific events, such as an important conference, a famous concert, a baseball game, etc.

However, some of the videos may repeatedly play the similar content again and again, but the user may not aware that the similar content will be played again and again until the user watches the whole video from the beginning to the end. Namely, the user is not able to skip the repeated content of the video. Therefore, the repeated content of the video may make the user feel bored and watching the whole video from the beginning to the end is time-consuming. In some cases, the user may drag an index of a playback timeline of the video for searching important content of the video, which causes that the important content of the video may be missed easily.

### SUMMARY OF THE INVENTION

Accordingly, the present invention is directed to a video analyzing method and a video processing apparatus, which are capable of recognizing repeated content of a video so as to greatly enhance user experience.

According to one of the exemplary embodiments, a video analyzing method adapted to a video processing apparatus is provided, and the video analyzing method includes the following steps. A video is received and the video is decoded to obtain a plurality of frames. The video is divided into a plurality of video segments according to content of the video by analyzing the frames of the video. A similarity level between any two of the video segments is determined by comparing at least one video attribute of the video segments. A repeat frequency of the video segments is identified according to the similarity level between any two of the video segments.

According to one of the exemplary embodiments, the step of dividing the video into the video segments according to the content of the video by analyzing the frames of the video includes the following steps. A frame information of the frames is calculated. The video is divided into the video segments by comparing the frame information of the frames to determine whether to divide the video at a time point.

According to one of the exemplary embodiments, the step of determining the similarity level between the any two of the video segments by comparing the at least one video attribute of the video segments includes the following steps. The at least one video attribute of the video segments is recognized. The at least one video attribute of the any two the video segments is compared. The similarity level between the any two of the video segments is obtained according to whether the at least one video attribute of the any two of the video segments is the same or whether the at least one video attribute of the any two the video segments is close enough.

According to one of the exemplary embodiments, the at least one video attribute comprises a first video attribute and a second video attribute, and the step of obtaining the similarity level between the any two of the video segments according to whether the at least one video attribute of the any two of the video segments is the same or whether the at least one video attribute of the any two the video segments is close enough includes the following steps. A first similarity grade associated with the first video attribute between the any two of the video segments is obtained and a second similarity grade associated with the second video attribute between the any two of the video segments is obtained. The similarity level between the any two of the video segments is calculated according to the first similarity grade, the second similarity grade, a first weight corresponding to the first similarity grade and a second weight corresponding to the second similarity grade.

According to one of the exemplary embodiments, the step of obtaining the first similarity grade associated with the first video attribute between the any two of the video segments and obtaining the second similarity grade associated with the second video attribute between the any two of the video segments includes following steps. If the first video attribute of the any two of the video segments is the same, the first similarity grade is set as a first parameter between the any two of the video segments. If the first video attribute of the any two of the video segments is not the same, the first similarity grade is set as a second parameter between the any two of the video segments. If the second video attribute of the any two of the video segments is close enough, a second similarity grade is set as a third parameter between the any two of the video segments. If the second video attribute of the any two of the video segments is not close enough, the second similarity grade is set as a forth parameter between the any two of the video segments.

According to one of the exemplary embodiments, the step of identifying the repeat frequency of the video segments includes the following steps. The video segments is classified into a plurality of similarity groups according to the similarity level. The repeat frequency of the video segments is obtained according to the numbers of the video segments in each of the similarity groups.

According to one of the exemplary embodiments, the step of classifying the video segments into the similarity groups according to the similarity level includes the following steps. If the similarity level between a first segment of the video segments and a second segment of the video segments is greater than a threshold, the first segment and the second segment are classified into a first group of the similarity groups. If the similarity level between a first segment and a second segment of the video segments is not greater than the threshold, the first segment and the second segment are respectively classified into the first group and a second group of the similarity groups.

According to one of the exemplary embodiments, the method further includes the following steps. A maximum repeat frequency is searched from all of the repeat frequency of the video segments, wherein the maximum repeat frequency is corresponding to a focusing segment of the video segment. The focusing segment of the video segments is played when receiving a user command selecting the video.

According to one of the exemplary embodiments, the method further includes the following steps. A list recording the at least one video attribute of each of the video segments is provided. When receiving a user command selecting one of the at least one video attribute, one of the video segments which is corresponding to the one of the at least one video attribute is played.

According to one of the exemplary embodiments, a video processing apparatus is provided. The video processing apparatus includes a memory storing a plurality of instructions and a processor coupled to the memory and configured for executing the instructions to: receive a video and decoding the video to obtain a plurality of frames; divide the video into a plurality of video segments according to content of the video by analyzing the frames of the video; determine a similarity level between any two of the video segments by comparing at least one video attribute of the video segments; and identify a repeat frequency of the video segments.

Based on above, according to a video analyzing method and a video processing apparatus, the video is divided into a plurality of video segments according to the content of the video. The similarity level between one of the video segments and the other video segments is defined based on at least on video attribute of the video segments. Therefore, the video processing apparatus may directly play important content of the video by playing one video segment whose repeat frequency is high, such that the user may directly watch the important content of the video and skip the repeated content without redundant operation, which effectively advances the user experience.

In order to make the aforementioned features and advantages of the present disclosure comprehensible, preferred embodiments accompanied with figures are described in detail below. It is to be understood that both the foregoing general description and the following detailed description are exemplary, and are intended to provide further explanation of the disclosure as claimed.

It should be understood, however, that this summary may not contain all of the aspect and embodiments of the present disclosure and is therefore not meant to be limiting or restrictive in any manner. Also the present disclosure would include improvements and modifications which are obvious to one skilled in the art.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating a video processing apparatus according to an embodiment of the invention.

FIG. 2 is a flowchart illustrating the video analyzing method according to an embodiment of the invention.

FIG. 3 is a schematic diagram illustrating dividing the video into the video segments according to an embodiment of the invention.

FIG. 4 is a schematic diagram illustrating the video analyzing method according to an embodiment of the invention.

FIG. 5 is a flowchart illustrating detecting the video analyzing method according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

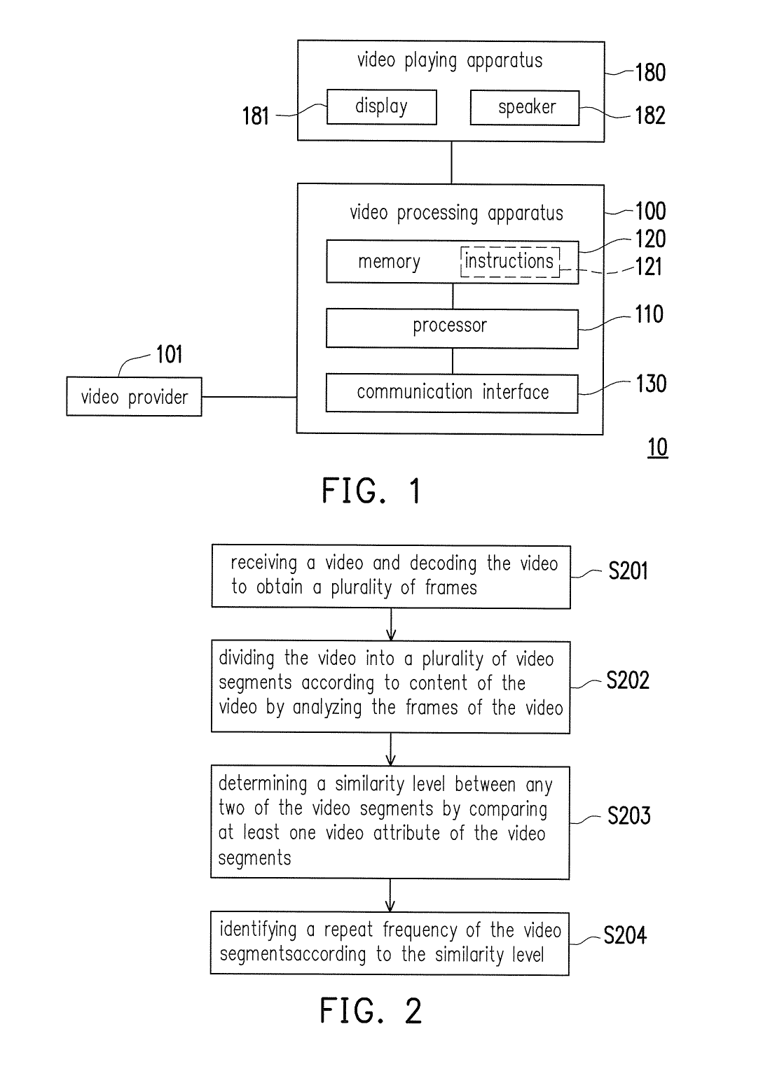

FIG. 1 is a block diagram illustrating a video processing apparatus according to an embodiment of the invention. Please referring to FIG. 1, a video playback system 10 includes a video processing apparatus 100, a video playing apparatus 180 and a video provider 101, and the video processing apparatus 100 is connected to the video provider 101 and the video playing apparatus. The video processing apparatus 100 is an electronic device having video processing capability, such as a set-top box (STB), a DVD player or a Home video game console, a desktop computer, a notebook, a smart phone, a personal digital assistant (PDA), or an online server, etc., but the invention is not limited thereto.

The video processing apparatus 100 is able to receive video data from the video provider 101. In one exemplary embodiment, the video provider 101 may be a multimedia providing server, and the video processing apparatus 100 may receive the video data to be played via Internet. The multimedia providing server may be, for example, a server providing a video-sharing website or a servers providing social network service, but the invention is not limited thereto. In one exemplary embodiment, the video processing apparatus 100, that is able to store video data by itself or is able to read a recording medium storing video data, may be regarded as a video provider as well.

The video playing apparatus 180 includes a display 181 and a speaker 182, and the video processing apparatus 100 may be electrically connected to the video playing apparatus 180 directly or connected to the video playing apparatus 180 via Internet. The video playing apparatus 180 may play video, audio or image supplied by the video processing apparatus 100 through the display 181 and the speaker 180. In one exemplary embodiment, the video processing apparatus 100 may be combined with the video playing apparatus 180 to form a desktop computer, a notebook, a smart phone, etc., which is not limited by the invention. In one exemplary embodiment, the video processing apparatus 100 and the video playing apparatus 180 may be two independent electronic device connected with each other via Internet.

In detail, please referring to FIG. 1, the video processing apparatus 100 includes a processor 110, a memory 120, and a communication interface 130. The memory 120 is used for storing data and instructions 121. For example, the memory 120 may include non-transitory storage medium, such as at least one of a hard disk, a memory, and an external storage medium (for example, a flash drive), or a combination thereof, which is not limited by the invention. In an exemplary embodiment, the memory 120 may also include transitory storage medium, such as RAM, which is not limited by the invention.

In an exemplary embodiment, the video processing apparatus 100 may include the communication interface 130 to provide the video processing apparatus 100 with cable communication, wireless communication and/or Internet connectivity. The communication interface 130 may, for example, include a network interface card (NIC), or may include a wireless network adapter supporting wireless communication protocols such as Bluetooth, Wi-Fi (wireless compatibility certification) and/or mobile network (eg. Third/fourth generation mobile communication technology). Further, the communication interface 130 may include both the NIC and the wireless network adapter, which the invention is not limited to.

The processor 110 is coupled to the memory 120 and configured for executing the instructions 121. For example, the processor 110 may perform video processing functions on a video file, such as compressing/decompressing, and/or coding/decoding, etc., though the invention is not limited thereto. For example, the processor 110 may be a central processing unit (CPU) and/or a microprocessor, though the invention is not limited thereto. Moreover, in an exemplary embodiment, after decoding the video file, the processor 110 may obtain video content and audio content of the video file, and the processor 110 may be configured to process video content and audio content respectively. By executing the instructions 121 in the memory 120, the processor 110 may be configured to analyze a digital video to obtain at least one video segment of the digital video, wherein a specific recognition result is shown in the at least one video segment.

To be specific, FIG. 2 is a flowchart illustrating the video analyzing method according to an embodiment of the invention. Referring to FIG. 1 and FIG. 2 together, the method of the present embodiment is suitable for the video processing apparatus 100, and detailed steps in the method of the present embodiment are described below with reference to each component of the video processing apparatus 100 in FIG. 1.

In step S201, the processor 110 may receive a video and decoding the video to obtain a plurality of frames. When the video playing apparatus 180 plays the received video, the frames of the video would be displayed at a unique time point of the playback timeline of the video. In step S202, the processor 110 may divide the video into a plurality of video segments according to content of the video by analyzing the frames of the video. In detail, the frames of the video are sequentially arranged based on each of the time points respectively corresponding to the frames, and the two adjacent frames are compared to detect whether the displayed scene in the video content is obviously changed at a specific time point. It should be noted that, the numbers of the video segments and the length of each of the video segments are not limited in the invention.

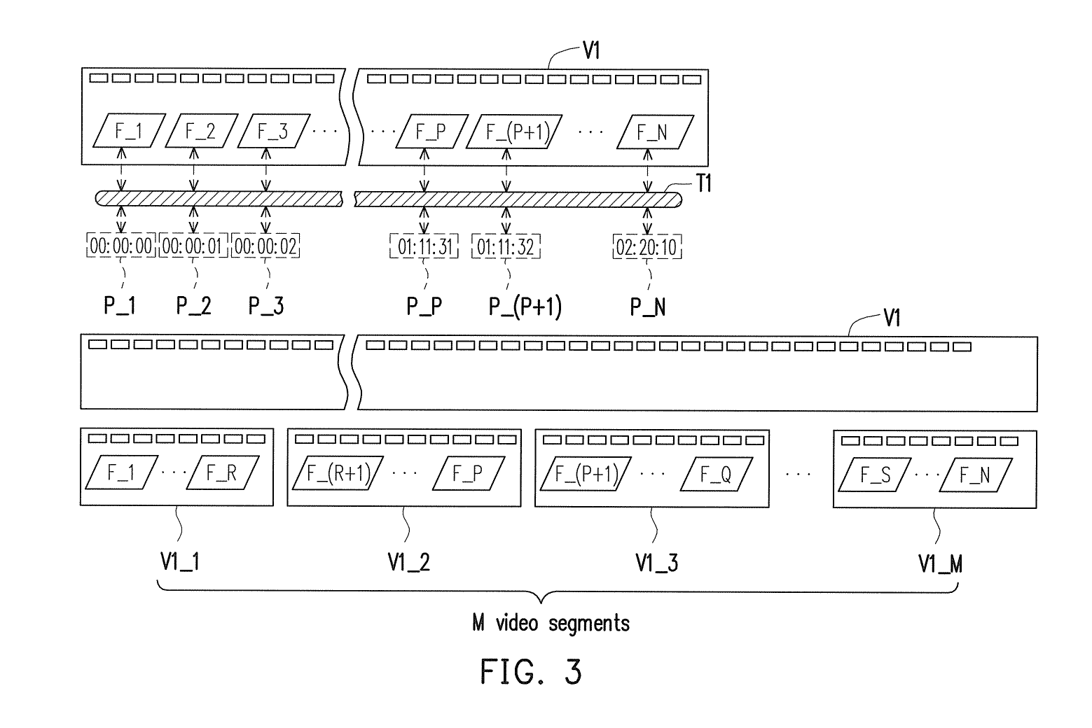

For example, FIG. 3 is a schematic diagram illustrating dividing the video into the video segments according to an embodiment of the invention. Please referring to FIG. 3, after decoding the video V1, the processor 110 may obtain N frames F_1, F_2, F_3, . . . , F_N, and each of the frames F_1 to F_N is respectively associated with a time point P_1, P_2, P_3, . . . , P_N on a playback timeline T1. For example, the frame F_P is associated with the time point P_P “01:11:31”, and the frame F_(P+1) is associated with the time point P_(P+1) “01:11:32”. Each of the frames F_1 to F_N is compared with the other two adjacent frames. For example, the frame F_2 is compared with the frames F_1 and F_3 respectively, so as to determine whether a scene change occurs at the time point P_2 or at the time point P_3.

Specifically, to say, the processor 110 may calculate a frame information of the frames F_1 to F_N, and then the processor 110 may divide the video V1 into M video segments V1_1, V1_2, V1_3, . . . , V1_M by comparing the frame information of the frames F_1 to F_N to determine whether to divide the video V1 at a time point. For example, the frame information of the frames F_1 to F_N may be pixel values or a color histogram, but the invention is not limited thereto. Afterward, the processor 110 may divide the video V1 into the M video segments V1_1, V1_2, V1_3, . . . , V1_M according to a difference of the frame information of the two adjacent frames. In the exemplary of FIG. 3, the video segment V1_1 includes the frames F_1 to F_R, and the video segment V1_2 includes the frames F_(R+1) to F_P. That is, the scene change occurs at the time point of the frame F_(R+1) is determined by the processor 110 according to the difference between the frame information of the frame F_R and the frame information of the frame F_(R+1), such that the video segment V1_1 is generated and the beginning time point and the ending time point of video segment V1_1 are obtaining thereof. Similarly, the scene change occurs at the time point P_(P+1) of the frame F_(P+1) is determined by the processor 110 according to the difference between the frame information of the frame F_P and the frame information of the frame F_(P+1), such that the video segment V1_2 is generated and the beginning time point and the ending time point of video segment V1_2 are obtaining thereof. Based on the same steps described above, the video segment V1_3 including the frames F_(P+1) to F_Q and the video segment V1_M including the frames F_S to F_N are generating.

Afterward, please referring back to FIG. 2, in step S203, the processor 110 may determine a similarity level between any two of the video segments by comparing at least one video attribute of the video segments. The processor 110 may determine the similarity level between any two of the video segments, so as to determine whether the any two of the video segments carry the repeated content. In one exemplary embodiment, the similarity level between any two of the video segments is parameterized in term of a parameter calculated by the processor 110 according to the video attribute of the any two of video segments. Further, the video attribute of the video segments may be a human feature captured from the video segments, a scene feature captured from the video segments, statistics information of pixels the video segments, but the invention is not limited thereto.

After obtaining the similarity level between any two of the video segments, in step S204, the processor 110 may identify a repeat frequency of the video segments according to the similarity level. In one exemplary embodiment, if the similarity level between two of the video segments is high, the video contents of the two of the video segments are repeated. Furthermore, in one exemplary embodiment, the default value of the repeat frequency of each of the video segments may be initialized to be zero, and the repeat frequency of each of the video segments may increase along with the number of the video segments having the repeated content.

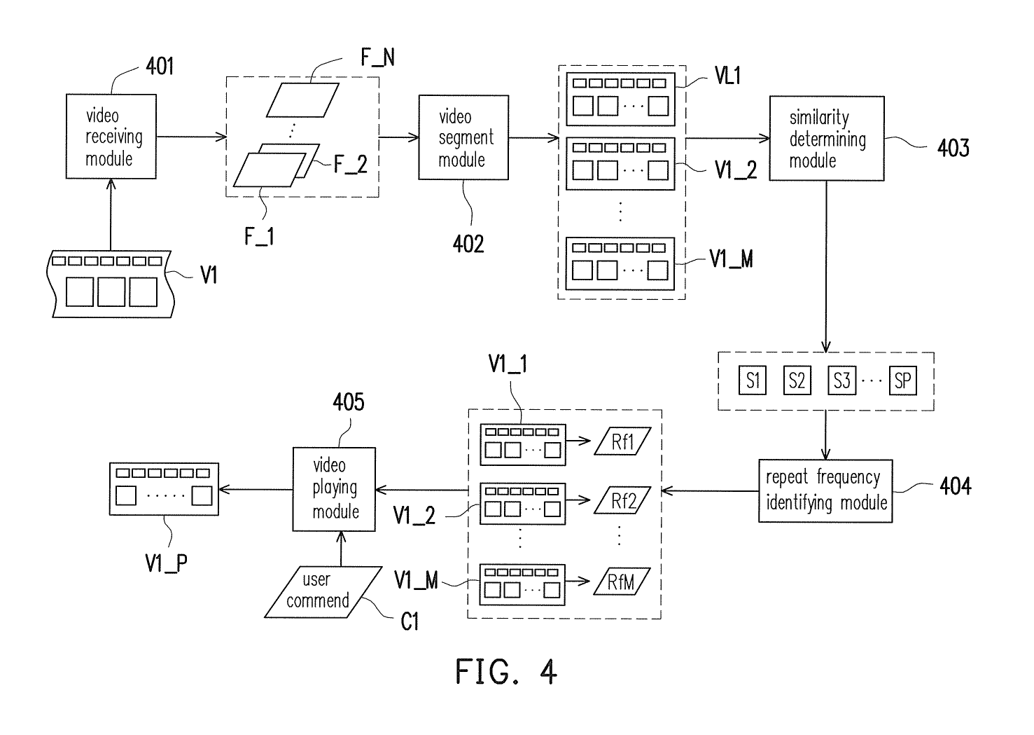

FIG. 4 is a schematic diagram illustrating the video analyzing method according to an embodiment of the invention. Referring to FIG. 1 and FIG. 4 together, the method of the present embodiment is suitable for the video processing apparatus 100. In the exemplary embodiment of FIG. 4, it is assuming that the instructions 121 recorded in the memory 120 of the video processing apparatus 100 may include a plurality of modules, and the processor 110 may execute each of the modules to implement the video processing and playing method (but the invention is not limited thereto). In the exemplary embodiment of FIG. 4, the modules include a video receiving module 401, a video segment module 402, a similarity determining module 403, a repeat frequency identifying module 404, and a video playing module 405. In the other embodiments, the video receiving module 401, the video segment module 402, the similarity determining module 403, the repeat frequency identifying module 404, and the video playing module 405 may be implemented by software, firmware, hardware or a combination thereof, which is not limited by the invention. The software is, for example, source codes, operating system, application software or driving program, etc. The hardware is, for example, a central processing unit (CPU), or other programmable general-purpose or special-purpose microprocessor.

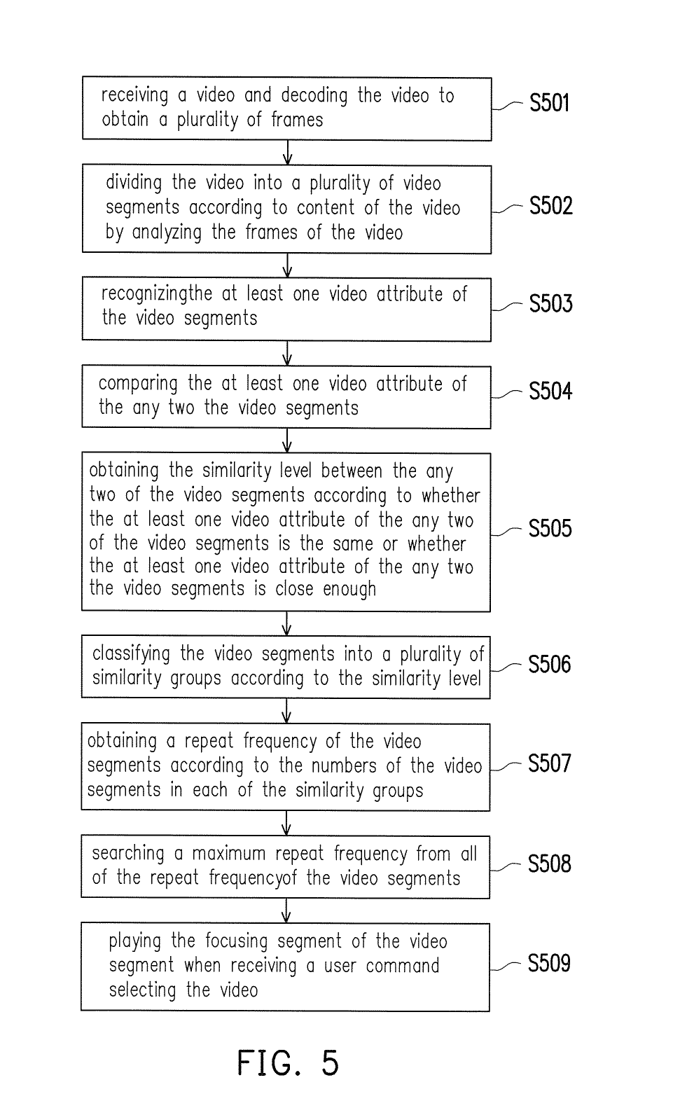

FIG. 5 is a flowchart illustrating detecting the video analyzing method according to an embodiment of the invention. Referring to FIG. 4 and FIG. 5 together, in step S501, the processor 110 executing the video receiving module 401 is configured to receive a video V1 and decode the video V1 to obtain a plurality of video frames F_1 to F_N. In step S502, the processor 110 executing the video segment module 402 is configured to divide the video V1 into a plurality of video segments V1_1 to V1_M according to content of the video V1 by analyzing the frames F_1 to F_N of the video V1. Next, in step S503, the processor 110 executing the similarity determining module 403 is configured to recognize the at least one video attribute of the video segments V1_1 to V1_M, such as a character recognized from the video segments V1_1 to V1_M, a scene type recognized from the video segments V1_1 to V1_M, a statistics of brightness of the frames F_1 to F_N in each of the video segments V1_1 to V1_M, etc., but the invention is not limited thereto.

In step S504, the processor 110 executing the similarity determining module 403 is configured to compare the at least one video attribute of the any two the video segments V1_1 to V1_M. In step S505, the processor 110 executing the similarity determining module 403 is configured to obtain the similarity level S1 to SP between the any two of the video segments V1_1 to V1_M according to whether the at least one video attribute of the any two of the video segments V1_1 to V1_M is the same or whether the at least one video attribute of the any two the video segments V1_1 to V1_M is close enough. Herein, whether the video attribute of the any two the video segments may be regarded as whether a difference between the video attribute of the any two the video segments is less than a threshold.

For example, if the video attribute is assuming as a recognized character, the processor 110 may determine the similarity level Si to SP between the any two of the video segments V1_1 to V1_M according to whether the recognized character in the any two of the video segments V1_1 to V1_M is the same. On the other hand, if the video attribute is assuming as a statistics of the pixels, the processor 110 may determine the similarity level S1 to SP between the any two of the video segments V1_1 to V1_M according to whether the statistics of the pixels of the any two of the video segments V1_1 to V1_M is close enough.

In an exemplary embodiment, the at least one video attribute includes a first video attribute and a second video attribute, and the similarly level between the video segments V1_1 to V1_M may be obtained according to the first video attribute and the second video attribute of the video segments V1_1 to V1_M. More specifically, a first similarity grade associated with the first video attribute between the any two of the video segments V1_1 to V1_M is obtained, and a second similarity grade associated with the second video attribute between the any two of the video segments V1_1 to V1_M is obtained. Next, the similarity level between the any two of the video segments V1_1 to V1_M is calculated according to the first similarity grade, the second similarity grade, a first weight corresponding to the first similarity grade and a second weight corresponding to the second similarity grade. Herein, the first weight and the second weight, which may be respectively regarded as the reference proportion of the first video attribute and the second video attribute, are calculation coefficients for calculating the similarity level. The first weight and the second weight may be default values or set by the user, and the invention is not limited thereto.

For example, the similarity level between the video segments V1_1 and V1_2 may be obtained by using Formula (1).

S1=W1*G1+W2*G2 Formula (1),

wherein S1 represents the similarity level between the video segments V1_1 and V1_2, W1 represents the first weight associated with the first video attribute, W2 represents the second weight associated with the second video attribute, G1 represents the first similarity grade associated with the first video attribute between the video segments V1_1 and V1_2, G2 represents the second similarity grade associated with the second video attribute between the video segments V1_1 and V1_2. Similarly, the similarity level S2 to SP between any other two video segments may be obtained according to the Formula (1). However, Formula (1) is only an exemplary, and the invention is not limited thereto.

Furthermore, in an exemplary embodiment, based on the type of the first video attribute is a recognized result, if the first video attribute of the any two of the video segments V1_1 to V1_M is the same, the first similarity grade is set as a first parameter between the any two of the video segments. By contrary, if the first video attribute of the any two of the video segments V1_1 to V1_M is not the same, the first similarity grade is set as a second parameter between the any two of the video segments. The first parameter is different from the second parameter. For example, the first parameter may be ‘1’ and the second parameter may be ‘0’. On the other hand, based on the type of the first video attribute is a statistic result, if the second video attribute of the any two of the video segments V1_1 to V1_M is close enough, a second similarity grade is set as a third parameter between the any two of the video segments V1_1 to V1_M. By contrary, if the second video attribute of the any two of the video segments V1_1 to V1_M is not close enough, the second similarity grade is set as a forth parameter between the any two of the video segments V1_1 to V1_M. The third parameter is different from the forth parameter. Herein, whether the second video attribute of the any two of the video segments V1_1 to V1_M is close enough may be determining according to the difference value obtaining by subtracting the statistic result of one of the video segments V1_1 to V1_M form the statistic result of another one of the video segments V1_1 to V1_M. If the difference value of the two statistic results is greater than a threshold, the second video attribute of the any two of the video segments V1_1 to V1_M is determined as being not close enough and is set as the forth parameter. On the contrary, if the difference value of the two statistic results is not greater than the threshold, the second video attribute of the any two of the video segments V1_1 to V1_M is determined as being close enough and is set as the third parameter. For example, the statistic result may be an average gray level of the pixels, and whether the second video attribute of the video segment V1_1 and the second video attribute of the video segment V1_2 is close enough may be determining according to the difference value by subtracting the average gray level of the video segment V1_1 from the average gay level of the video segment V1_2.

Furthermore, the second similarity grade may be determined to be the third parameter or the forth parameter by inputting the difference value into a linear function, wherein the difference value is calculating by using the second video attribute of the any two of the video segments V1_1 to V1_M. Herein, the linear function may be a decreasing function, and the third parameter or the forth parameter may be the outputting result of the predefine function. The third parameter or the forth parameter is decreasing along with the increasing of the difference value of the two statistic results. For example, the second similarity grade between the video segments V1_1 and V1_2 may be obtained by using Formula (2).

G2=a*diff+b Formula (2),

wherein diff represents an absolute value of the difference value of the two statistic results between the video segments V1_1 and V1_2, a represents a function coefficient less than 0, b represents a function constant, and G2 represents the second similarity grade associated with the second video attribute between the video segments V1_1 and V1_2. Similarly, the second similarity grade between any other two video segments may be obtained according to the Formula (2). However, Formula (2) is only an exemplary, and the invention is not limited thereto. After the similarly level S1 to SP is obtained, the processor 110 executing the repeat frequency identifying module 404 is configured to identify the repeat frequency RF1 to RFM of the video segments V1_1 to V1_M according to the similarity level Si to SP. More specifically, in step S506, the processor 110 executing the repeat frequency identifying module 404 is configured to classify the video segments V1_1 to V1_M into a plurality of similarity groups according to the similarity level S1 to SP. In step S507, the processor 110 executing the repeat frequency identifying module 404 is configured to obtain the repeat frequency RF1 to RFM of the video segments V1_1 to V1_M according to the numbers of the video segments in each of the similarity groups.

In an exemplary embodiment, if the similarity level between a first segment of the video segments and a second segment of the video segments V1_1 to V1_M is greater than a threshold, the first segment and the second segment are classified into a first group of the similarity groups. If the similarity level between a first segment and a second segment of the video segments V1_1 to V1_M is not greater than the threshold, the first segment and the second segment are respectively classified into the first group and a second group of the similarity groups. Table I is provided herein for illustrating an exemplary of identifying the repeat frequency RF1 to RFM of the video segments V1_1 to V1_M according to the similarity level S1 to SP.

TABLE I

| | | the number of the |
|---|---|---|
| | | video segments per |
| Similarity Groups | Video Segments | similarity group |
| similarity group I | video segment V1_1 | 1 |
| similarity group II | video segment V1_2, | 3 |
| | video segment V1_5, | |
| | video segment V1_10 | |
| similarity group III | video segment V1_3, | 10 |
| | video segment V1_7, | |
| | . . . | |
| | video segment V1_21 | |
| . . . | . . . | . . . |

According to Table I, only the video segment V1_1 is classified in to the similarity group I, and the repeat frequency RF1 of the video segment V1_1 is set as ‘1’. Furthermore, the similarity level between the video segment V1_2 and the video segment V1_5 is greater than a threshold, the video segment V1_2 and the video segment V1_5 are classified into the similarity group II. The similarity level between the video segment V1_2 and the video segment V1_10 is greater than a threshold, the video segment V1_2 and the video segment V1_10 are classified into the similarity group II. Therefore, the repeat frequency RF2 of the video segment V1_2 is set as ‘3’.

Please referring to FIG. 4 and FIG. 5 together again, in step S508, the processor 110 executing the video playing module 405 is configured to search a maximum repeat frequency from all of the repeat frequency RF1 to RFM of the video segments V1_1 to V1_M. Afterward, in step S509, the processor 110 executing the video playing module 405 is configured to play the focusing segment V1_P of the video segment V1_1 to V1_M when receiving a user command C1 selecting the video V1.

It should be noted that, in one exemplary embodiment, a list recording the at least one video attribute of each of the video segments is provided to the user. When receiving a user command selecting one of the at least one video attribute, one of the video segments which is corresponding to the one of the at least one video attribute is played. For example, a list having a plurality of items corresponding to the video attribute of each of the video segments is displayed on the screen, and the user may control the video apparatus to play a video segment which the user is interesting in by selecting one of the items.

In summary, according to the video analyzing method and the video processing apparatus in the invention, the video is divided into the video segments, and whether the video segments carry the repeated content is determined, wherein a video segment corresponding to the maximum repeat frequency may be regarded as a focusing video segment. Therefore, by playing the focusing video segment directly, the user may skip the redundant part of the video and get the important information in the video immediately without any complicated operation, which effectively advances the user experience. Furthermore, the video segments may be classified in to the similarity groups according to the video attribute, such that the user is able to choose the video segment which the user is interesting according to the classify result of the video segments.

Since the invention does not limit what device to perform the video processing and playing method, and the device may be, for example, an electronic device of a client or a multimedia file sharing device of a server, so that the invention may be directly used in various electronic devices with multimedia file playing function or multimedia file playing software on the present market.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A video analyzing method, adapted to a video processing apparatus, comprising:
receiving a video and decoding the video to obtain a plurality of frames;
dividing the video into a plurality of video segments according to content of the video by analyzing the frames of the video;
determining a similarity level between any two of the video segments by comparing at least one video attribute of the video segments; and
identifying a repeat frequency of the video segments according to the similarity level.

2. The video analyzing method according to claim 1, wherein the step of dividing the video into the video segments according to the content of the video by analyzing the frames of the video comprises:
calculating a frame information of the frames; and
dividing the video into the video segments by comparing the frame information of the frames to determine whether to divide the video at a time point.

3. The video analyzing method according to claim 1, wherein the step of determining the similarity level between the any two of the video segments by comparing the at least one video attribute of the video segments comprises:
recognizing the at least one video attribute of the video segments;
comparing the at least one video attribute of the any two the video segments; and
obtaining the similarity level between the any two of the video segments according to whether the at least one video attribute of the any two of the video segments is the same or whether the at least one video attribute of the any two the video segments is close enough.

4. The video analyzing method according to claim 3, wherein the at least one video attribute comprises a first video attribute and a second video attribute, and the step of obtaining the similarity level between the any two of the video segments according to whether the at least one video attribute of the any two of the video segments is the same or whether the at least one video attribute of the any two the video segments is close enough comprises:
obtaining a first similarity grade associated with the first video attribute between the any two of the video segments and obtaining a second similarity grade associated with the second video attribute between the any two of the video segments; and
calculating the similarity level between the any two of the video segments according to the first similarity grade, the second similarity grade, a first weight corresponding to the first similarity grade and a second weight corresponding to the second similarity grade.

5. The video analyzing method according to claim 4, and the step of obtaining the first similarity grade associated with the first video attribute between the any two of the video segments and obtaining the second similarity grade associated with the second video attribute between the any two of the video segments comprises:
if the first video attribute of the any two of the video segments is the same, setting the first similarity grade as a first parameter between the any two of the video segments;
if the first video attribute of the any two of the video segments is not the same, setting the first similarity grade as a second parameter between the any two of the video segments;
if the second video attribute of the any two of the video segments is close enough, setting a second similarity grade as a third parameter between the any two of the video segments; and
if the second video attribute of the any two of the video segments is not close enough, setting the second similarity grade as a forth parameter between the any two of the video segments.

6. The video analyzing method according to claim 1, wherein the step of identifying the repeat frequency of the video segments comprises:
classifying the video segments into a plurality of similarity groups according to the similarity level; and
obtaining the repeat frequency of the video segments according to the numbers of the video segments in each of the similarity groups.

7. The video analyzing method according to claim 6, wherein the step of classifying the video segments into the similarity groups according to the similarity level comprises:
if the similarity level between a first segment of the video segments and a second segment of the video segments is greater than a threshold, classifying the first segment and the second segment into a first group of the similarity groups; and
if the similarity level between a first segment and a second segment of the video segments is not greater than the threshold, respectively classifying the first segment and the second segment into the first group and a second group of the similarity groups.

8. The video analyzing method according to claim 1, further comprising:
searching a maximum repeat frequency from all of the repeat frequency of the video segments, wherein the maximum repeat frequency is corresponding to a focusing segment of the video segment; and
playing the focusing segment of the video segment when receiving a user command selecting the video.

9. The video analyzing method according to claim 1, further comprising:
providing a list recording the at least one video attribute of each of the video segments; and
when receiving a user command selecting one of the at least one video attribute, playing one of the video segments which is corresponding to the one of the at least one video attribute.

10. A video processing apparatus, comprising:
a memory, storing a plurality of instructions; and
a processor, coupled to the memory and configured for executing the instructions to:
receive a video and decoding the video to obtain a plurality of frames;
divide the video into a plurality of video segments according to content of the video by analyzing the frames of the video;
determine a similarity level between any two of the video segments by comparing at least one video attribute of the video segments; and
identify a repeat frequency of the video segments according to the similarity level.

11. The video processing apparatus according to claim 10, wherein the processor is configured to calculate a frame information of the frames, and the processor is configured to divide the video into the video segments by comparing the frame information of the frames to determine whether to divide the video at a time point.

12. The video processing apparatus according to claim 10, wherein the processor is configured to recognize the at least one video attribute of the video segments, the processor is configured to compare the at least one video attribute of the any two the video segments, and the processor is configured to obtain the similarity level between the any two of the video segments according to whether the at least one video attribute of the any two of the video segments is the same or whether the at least one video attribute of the any two the video segments is close enough.

13. The video processing apparatus according to claim 12, wherein the at least one video attribute comprises a first video attribute and a second video attribute, the processor is configured to obtain a first similarity grade associated with the first video attribute between the any two of the video segments and obtaining a second similarity grade associated with the second video attribute between the any two of the video segments, and the processor id configured to calculate the similarity level between the any two of the video segments according to the first similarity grade, the second similarity grade, a first weight corresponding to the first similarity grade and a second weight corresponding to the second similarity grade.

14. The video processing apparatus according to claim 13, wherein the processor is configured to set the first similarity grade as a first parameter between the any two of the video segments if the first video attribute of the any two of the video segments is the same, the processor is configured to set the first similarity grade as a second parameter between the any two of the video segments if the first video attribute of the any two of the video segments is not the same, the processor is configured to set a second similarity grade as a third parameter between the any two of the video segments if the second video attribute of the any two of the video segments is close enough, and the processor is configured to set the second similarity grade as a forth parameter between the any two of the video segments if the second video attribute of the any two of the video segments is not close enough.

15. The video processing apparatus according to claim 10, wherein the processor is configured to classify the video segments into a plurality of similarity groups according to the similarity level, and the processor is configured to obtain the repeat frequency of the video segments according to the numbers of the video segments in each of the similarity groups.

16. The video processing apparatus according to claim 15, wherein the processor is configured to classify the first segment and the second segment into a first group of the similarity groups if the similarity level between a first segment of the video segments and a second segment of the video segments is greater than a threshold, and the processor is configured to respectively classify the first segment and the second segment into the first group and a second group of the similarity groups if the similarity level between a first segment and a second segment of the video segments is not greater than the threshold.

17. The video processing apparatus according to claim 10, wherein the processor is configured to search a maximum repeat frequency from all of the repeat frequency of the video segments, the maximum repeat frequency is corresponding to a focusing segment of the video segment, and the processor is configured to play the focusing segment of the video segment when receiving a user command selecting the video.

18. The video processing apparatus according to claim 10, wherein the processor s configured to provide a list recording the at least one video attribute of each of the video segments, and the processor is configured to play one of the video segments which is corresponding to the one of the at least one video attribute when receiving a user command selecting one of the at least one video attribute.
